(19) United States
(12) Patent Application Publication
(10) Pub. No.: US 2005/0149529 A1
(43) Pub. Date: Jul. 7, 2005

(54) Efficient handling of download requests

(76) Inventor: Andi Gutmans, Herzlia (IL)

Correspondence Address: ABELMAN, FRAYNE & SCHWAB, 150 East 42nd Street, New York, NY, 10017-5612, US

(21) Appl. No.: 10/750,719

(22) Filed: Jan. 2, 2004

(51) Int. Cl. G06F 17/30

(52) U.S. Cl. 707/10

(57) ABSTRACT

A server is capable of receiving large numbers of concurrent download requests, establishing TCP sessions with each client. A copy of the socket of each session, together with descriptor information of the file requested are transferred to a download manager, and the original connection immediately closed. The connection to the client remains open via the copy of the socket, which is then converted to a non-blocking socket by the download manager converts to copy of the socket to a non-blocking socket, and downloads the requested information to the client using the non-blocking socket and its own connection to the server. The arrangement is capable of dealing with loads that would ordinarily overwhelm the server's capability of establishing and maintaining individual TCP sessions with its clients. Heavy loads, including bursty peak loads, are handled gracefully, without causing the server to stall, or to refuse connections.

### BACKGROUND OF THE INVENTION

1. Field of the Invention

This invention relates to communications over a data network. More particularly, this invention relates to concurrent downloading of electronic files from the Internet or other communication channels.

2. Description of the Related Art

Demand for information over data networks, particularly the Internet, continues to increase rapidly. In a common mode of operation, a client requests information from a remote server, for example shared access to a file, or more indirectly, for data stored on a file that is accessible by the server. Alternatively, the client may request download of the entire file. On the Internet, well-established protocols for client-server interactions are the Internet Protocol (IP), the Transmission Control Protocol (TCP), HyperText Transmission Protocol (HTTP) and the File Transfer Protocol (FTP). The present invention deals primarily with problems of concurrency, in which multiple clients establish or attempt to establish connections, such as TCP sessions, with a server.

Each TCP session requires a memory buffer, and consumes resources on the server. This becomes a limiting factor when there are many clients simultaneously requesting service. Indeed, should memory resources become fully occupied, the server may be unable to respond to new client requests, and might even crash. Performance degradation tends to be nonlinear as saturation is approached, and the service can therefore appear to be blocked from the perspective of the client. Furthermore, TCP sessions typically employ blocking I/O, which is a further drawback in the context of the invention. When the downloads are large, or some clients have a slow transfer rate, the server essentially becomes I/O bound. The server CPU appears to be nearly idle; yet, no new clients can establish connections.

In one approach to this problem, the client load is distributed to other download servers, for example in a cluster. This approach is typified in the document, Mod_{—}Backhand, Internals Explained, Theo Schlossnagle, available on the Internet at the URL “http://www.backhand.org/ApacheCon2001/US/backhand_presentation .pdf.” A load-balancing algorithm is applied in order to select from among candidate servers to satisfy each new request. In one mode of operation, a client request is redirected to another server, using a HTTP redirect directive. In another mode of operation, the server acts as a proxy server, maintaining its connection with the client. The proxy technique still requires maintenance of many concurrent TCP sessions. Redirection requires opening new TCP sessions, and is relatively slow and inefficient. Furthermore, HTTP redirection is not transparent to the client. Thus, neither technique is optimal.

In another approach, typified by the thttpd web server, available from Acme Laboratories, a single process is employed to accommodate multiple client requests. This approach does not incur significant overhead per client; however, in the event of a process failure, all current client requests would be lost. The thttpd web server uses non-blocking I/O, and can accept a large number of connections, limited only by the capabilities of the operating system. This arrangement is optimized for file downloads, but is not efficient for many electronic commerce web servers, in which the client and the web server are interactive, or for servers having jobs that are blocking. Interactive Web sites are typically dynamic, operating under a scripting language. The scripts can take a long time to execute, and can cause the thttpd web server to stall.

Using a new thread to process each client request represents another approach. Multi-threading improves, but does not eliminate the server overhead. Multi-threading virtualizes server resources from the aspect of the client, and is well supported in modern development environments. However, it does incur overhead, caused for example, scheduling overhead, and lock contention. This can lead to serious performance degradation when the number of threads is large. In the context of an Internet service, concurrency demands can easily exceed the thread limit of practical servers. Examples of this approach are found in web servers, such as the Sun ONE Server™, available from Sun Microsystems Inc., Palo Alto, Calif. and the Internet Information Server (IIS) produced by Microsoft Corporation, One Microsoft Way, Redmond, Wash. 98052-6399. The above-noted limitations of this approach have been offset to some extent by bounding the thread pool.

Still another approach to concurrency involves event handlers, in which each client request represents an event that is processed from an event queue. Single-threaded event-driven designs tend not to degrade in performance when they are saturated by load, and the latency of each task increases linearly. A variant of the event-driven design is proposed in the document SEDA: An architecture for Well-Conditioned, Scalable Internet Services, M. Welsh, D. Culler, E. Brewer, 18th Symposium on Operating Systems Principles, Banff, Canada, October 2001, which discloses a set of independently managed stages separated by event queues. Some of the stages are operated sequentially, while others run in parallel in order to achieve good load balancing.

### SUMMARY OF THE INVENTION

According to the invention, large numbers of concurrent server requests, including bursty peak loads, are handled gracefully, without causing the server to stall, or to refuse connections. The principles of the invention are advantageously applied to web servers, which are less advanced in their capabilities of handling many concurrent requests, but which are still commonly found on the Internet. Accordingly, the useful operating life of such web servers can be greatly prolonged, and the increasing demands of Internet service can be met without need for expensive refitting or reinvestment in new server technology. The methods and systems according to the invention solve the problem of handling large numbers of concurrent server requests, even when the transfer rate between the server and the client is slow, without causing the server to block new requests, and without need for adding additional servers.

When a request for file download arrives at a web server from a client, which is typically a computer or workstation having a web browser, a process in the web server intercepts the request and optionally evaluates it. If the request meets criteria for acceptability, a further optional check may made against the status of the requested file. If the file is appropriate, the filename and/or open file descriptor, along with the file descriptor of a socket that connects the server to the client, are transmitted via a socket or other mechanism to a download manager, where it is enqueued. This is accomplished using the native facilities of the host server. The download manager, which is located in the same server, thereupon causes the file to be downloaded to the requestor. Once the request has been offloaded to the download manager, the web server's thread or process then closes its copy of the socket connection to the client. The web server is now free to serve the next incoming request from a client. The client is not affected by the closing of the connection, as a copy of the open socket connection now exists in the download manager. Because the connection between the client and the web server is short-lived, relatively few resources are consumed in the web server.

The invention provides a method for downloading data, which is carried out by establishing a connection over a communication network between a remote client and a server, the connection including a socket. The method is further carried out by receiving a download request from the client via the connection for download of information from the server, transferring the socket to a download manager process executing on the server, and transmitting the information to the client from the download manager process using the socket.

An aspect of the method includes converting the socket to a non-blocking socket.

In one aspect of the method, transferring the socket is performed by constructing a copy of the socket, thereafter closing the socket, and transferring the copy to the download manager process to define a second connection between the download manager process and the client using the copy.

In another aspect of the method, there are a plurality of clients. Establishing connections, and transferring sockets are performed substantially concurrently with respect to each of the clients.

In another aspect of the method, the download request also includes an indication of a file on the server and further includes enqueueing the download request in the download manager process with other pending download requests.

According to a further aspect of the method, the connection is a TCP session.

According to yet another aspect of the method, the socket of the connection is a blocking socket.

In yet another aspect of the method the server allows a maximum number of open file descriptors. The method is further carried out by spawning a duplicate download manager process, when the maximum number of open file descriptors is exceeded, performing receiving a download request in one of the download manager process and the duplicate download manager process, and servicing previously pending requests in the other of the download manager process and the duplicate download manager process.

The invention provides a computer software product, including a computer-readable medium in which computer program instructions are stored, which instructions, when read by a computer, cause the computer to perform a method for downloading files from the computer over a data network, which is carried out by intercepting a download request for information that is received via a first connection from a remote client, the first connection including a socket. The method is further carried out by installing a download manager in the computer, transmitting a set of data including the download request and a descriptor of the socket to the download manager to define a second connection between the download manager and the client using the descriptor, and downloading the information from the computer to the client via the second connection.

The invention provides a system for downloading information over a data network, including a server connectable to a plurality of clients across the data network via blocking sockets. The server is adapted to intercept download requests from the clients, and to associate each of the download requests with respective copies of the blocking sockets. A download manager executing in the server receives the download requests and the copies from the server. The download manager is adapted to convert the copies to non-blocking sockets, and the server thereupon closes the blocking sockets. The download manager causes the download requests to be serviced from the server across the data network via respective ones of the non-blocking sockets.

According to a further aspect of the system, the download manager is a subassembly of the server.

According to still another aspect of the system, the download manager includes a queue for holding the download requests, which are serviced in turn from the queue.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a high level schematic illustrating a networked client-server arrangement in which a download manager is implemented as a process on a web server, which is operative in accordance with an alternate embodiment of the invention;

FIG. 2 is a block diagram illustrating aspects of the operation of a download manager in the arrangement shown in FIG. 1;

FIG. 3 is a flow chart illustrating a method of processing concurrent download requests in a server in accordance with a disclosed embodiment of the invention; and

FIG. 4 is a flow diagram illustrating the details of passing a download request from a server to a download manager in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances well-known circuits, control logic, and the details of computer program instructions for conventional algorithms and processes have not been shown in detail in order not to unnecessarily obscure the present invention.

Software programming code, which embodies aspects of the present invention, is typically maintained in permanent storage, such as a computer readable medium. In a client-server environment, such software programming code may be stored on a client or a server. The software programming code may be embodied on any of a variety of known media, for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

The term “server hardware” as used herein refers to a physical apparatus that is accessed over a data network to perform server functions. The terms “server program” or “server application”, as used herein, denote programs executing on the physical device, it being understood that such server programs, while typically software, can also be implemented as hardware devices, or as combinations and subcombinations of software and hardware, and still remain within the scope and spirit of the invention. The unqualified term “server” refers to any structure that functions as a server on a data network, such as a web server, and subsumes server hardware and any server programs executing therein.

Turning now to the drawings, reference is initially made to FIG. 1, which is a high level schematic illustrating a networked client-server arrangement 10, and which is operative in accordance with a disclosed embodiment of the invention. A plurality of clients 12 are typically general-purpose computers or workstations, each having a memory 14 for an executing web browser 16. The clients 12, using their respective instances of the browser 16, form connections via a data network 18 to server hardware 20, and request files 22. The browser 16 can be any commercially available browser, such as the Netscape™ Browser, available from Netscape. Communications Corporation, P.O. Box 7050 Mountain View, Calif. 94039-7050, Internet Explorer™, available from Microsoft Corporation, One Microsoft Way, Redmond, Wash. 98052-6399, or the Mozilla™ Browser, available from The Mozilla Foundation c/o OSAF, 543 Howard St. 5th Floor, San Francisco, Calif. 94105. The network 18 is typically the Internet. The server hardware 20 executes a server program 24, such as the Apache HTTP Server program, ver. 1.3 or ver. 2.0, available from the Apache Software Foundation, (http://www.apache.org/), 1901 Munsey Drive. Forest Hill, Md. 21050-2747.

One current embodiment uses a Pentium-based machine as the server hardware 20, and is controlled by an operating system 26, which currently is the Linux® operating system, available from Red Hat, Inc, 1801 Varsity Drive, Raleigh, N.C. 27606. Another embodiment operates in a server using the SPARC™ processor as the server hardware 20 under the Solaris™ operating system, both available from Sun Microsystems, Inc., 4150 Network Circle, Santa Clara, Calif. 95054 However, the principles of the invention are not dependent on any particular processor architecture, operating system, or server software, and can be applied to many different servers, hardware configurations, and operating systems. The principles of the invention are effectively applied to web servers having limited efficiency in establishing concurrent TCP sessions, for example Pentium P3 or P4 based server hardware using some Apache server programs. However the invention may be applied to any server in which the server resources consumed by concurrent server-client sessions is a limitation in throughput, or in which the number of client requests exceed the server's ability to timely establish and maintain concurrent communication sessions.

Included in the server hardware 20 is a download manager 28. An interception process 30 in the server hardware 20 intercepts download requests originating from the clients 12 and transfers them to a queue 32 in the download manager 28, using the facilities of the server program 24 and the operating system 26 in a manner that is disclosed hereinbelow. The download manager 28, which is disclosed in further detail hereinbelow, is responsible for actually downloading the files 22 to the clients 12. Other client requests that do not involve large file downloads, such as requests for a page of a document, are ignored by the process 30, and are handled conventionally.

Operation.

Continuing to refer to FIG. 1, An operator at one of the clients 12 uses the browser 16 to select one or more files 22 for download from the server hardware 20 and to generate a download request. A communication channel, typically a TCP session, is established between the client and the server using the network 18, via a conventional client connection socket in the server hardware 20. It should be noted that the client connection socket is generally a blocking socket. That is, the process interacting with the socket does not progress until the client connection is fully established, and also does not progress during various I/O operations that may occur thereafter. After the connection is established, the download request is transmitted to the server hardware 20 When the download request arrives it is initially handled by the server program 24, and then intercepted by the process 30, which evaluates it according to predetermined criteria.

In the current version, the criterion for acceptance of the download request is a file type and size. However, many other criteria for acceptability are possible, e.g., access privilege, file size, connection speed, or geographic location of the clients 12. If the download request meets criteria for acceptability, a further check is made against the status of the requested file. If the file is outdated or deleted, then an appropriate response will be issued by the server. Alternatively, validating the request could be performed by the download manager 28, but is not as efficient, due to overhead in establishing a connection between the client connection session and the download manager 28.

The server program 24 maintains a connection with the download manager 28 via another socket, which is typically an unnamed socket. Alternatively, a named socket can be used. If the download request is validated, the filename and the descriptor of the client connection socket that connects the server program 24 with a particular one of the clients 12 is transmitted to the download manager 28 using the other socket and is enqueued in the queue 32. Thus, a copy of the client connection socket is effectively transferred from the server program 24 to the download manager 28. Additionally or alternatively, the file descriptor may be transmitted to the download manager 28. The transfer is accomplished using the facilities of the server program 24 and the operating system 26. A function suitable for transferring the client connection socket and file information from the server program 24 to the download manager 28 is shown in Listing 1. A function suitable for receiving the client connection socket and file information in the download manager 28 is shown in Listing 2. Memory mapped file I/O, using a system call such as mmap( ), has been found to be particularly useful in accessing the file information for download.

Once having offloaded the download request to the download manager 28, the server program 24 immediately closes its copy of the client connection socket. This can be done, for example, using the system call close( ). The server program 24 is now free to serve the next incoming download request. The client is not affected by the closing of the connection, as a copy of the open client connection socket now exists in the download manager 28, thus maintaining a communications channel between the download manager 28 and the client. Because the connections between the clients 12 and the server program 24 are short-lived, relatively few resources are consumed in the server hardware 20, and the combination of the server program 24 and the download manager 28 is able to handle more clients concurrently than would be possible using the server program 24 alone.

Alternatively, download requests can be sent to the download manager 28 using an application programming interface (API) function, which is normally supplied to a web site developer. This function may be written as a PHP:hypertext preprocessor (PHP) extension script that is executed using a Zend Engine (version 1 or higher. PHP is a widely used general-purpose scripting language that is especially suited for Web development, and can be embedded into hypertext markup language (HTML) documents. PHP (version 4 or higher) and the Zend engine are both available from Zend Technologies Ltd., P.O. Box 3619, Ramat Gan, Israel, 52136. An example of such an API function is the function “send_file (filename)”. This function automatically invokes the process of transferring the download request from the server hardware 20 to the download manager 28 as noted above. One advantage of this alternative increased data security. The requested file need not necessarily map to a valid URL, and the client need not be made aware of the true URL of the file.

The download manager 28 is automatically made aware of new download requests. This can be done using the select( ) system call, or the poll( ) call on UNIX-like systems such as the operating system 26. A blocking select( ) call is preferable, but a non-blocking select( ) call can also be used. When the download manager 28 discovers that there is a new socket/file pair to be processed, it is added to the queue 32. The socket is made non-blocking using a UNIX or Linux system call such as fcntl (fd, F_SETFL, flags|O_NDELAY), in which the identifiers F_SETFL and O_NDELAY have conventional meanings. Non-blocking I/O is used by the download manager 28 to efficiently service all concurrent downloads while awaiting additional incoming requests from the server hardware 20.

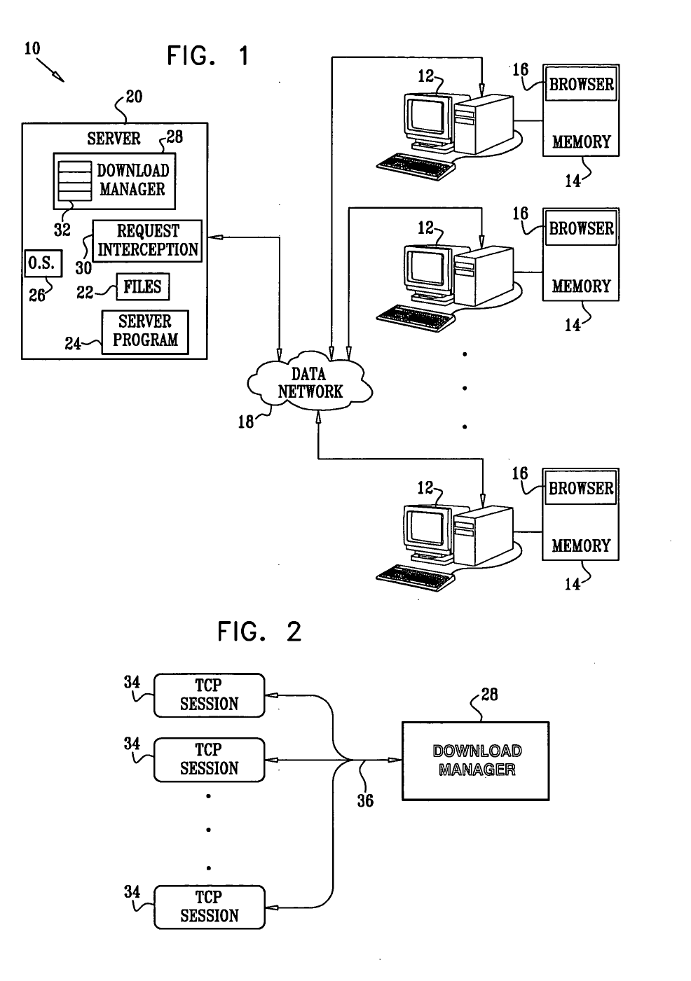

Referring again to FIG. 1, each download request on the queue 32 is processed serially in a loop. Reference is now made to FIG. 2, which is a block diagram illustrating in further detail the relationship of the download manager 28 (FIG. 1) with multiple instances of a TCP session process 34 that are enqueued in the queue 32. Each TCP session process 34 is spawned, using a system call such as fork( ). In this way, each TCP session process 34 shares an unnamed socket 36 that connects it with the download manager 28. Using an unnamed socket is efficient, and does not run the risk of name conflicts. However, should the unnamed socket fail, then all of the TCP session processes would fail. Each TCP session process 34 includes a different socket/file pair corresponding to the different pending requests. Advantageously, the arrangement of FIG. 2 is well adapted to support download accelerators, which open multiple concurrent connections with the same server.

Alternatively, a multi-threaded process may be used to download the requested file to the client via the network 18 when the server program 24 is multithreaded. As a further alternative, a multithreaded server sets up one thread per client connection. The download manager, executing as an additional thread, then serves all the clients concurrently, using non-blocking I/O to communicate via the client connections. The sockets of the client connections are first converted to non-blocking sockets. An important advantage of this embodiment is that the need for copying the client socket is avoided, an the implementation details are greatly simplified.

Referring again to FIG. 1, many known static or adaptive queue disciplines may be employed to manage the queue 32 in order to optimize throughput. For example, requests involving small files may be advanced to the head of the queue. One mode of operating the download manager 28 is given in a pseudocode fragment in Listing 3.

In the current embodiment, the download manager 28 is implemented as a process under control of the operating system 26. This is advantageous should the maximum number of open files per process permitted by the operating system be reached. In this event, the download manager 28 is forked. The child process continues to service the existing pending download requests, and terminates once all have completed. The parent process begins listening for new requests. This technique has been found to be superior to simply refusing new download requests. In some embodiments, in which the server program 24 is multithreaded, the download manager 28 can be implemented as a separate thread.

Establishment of Client Sessions.

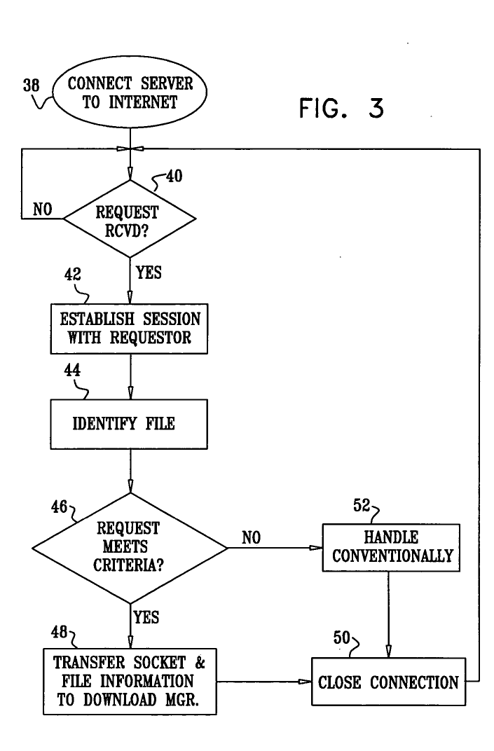

Reference is now made to FIG. 3, which is a flow chart illustrating a method of processing concurrent download requests in accordance with a disclosed embodiment of the invention. It will be understood that while a linear sequence of events is illustrated for clarity of presentation, many of the steps shown are actually executed concurrently. Thus, a sequence involving one download request is illustrated. However, simultaneous instances of the sequence are typically ongoing in different stages.

At initial step 38 a server having access to desirable files is connected to the Internet. Control now passes to delay step 40, where a download request is awaited.

When a request is received, control passes to step 42 a communication session, typically a TCP session, is established between the server and the requester. The TCP session uses a socket, which is subject to blocking.

Next, at step 44 the file requested to be downloaded is identified.

Next, at decision step 46 an analysis is undertaken to determine whether the request is appropriate to be handled via the download manager. In general, large file downloads are passed to the download manager and small downloads and script execution are handled by the conventional web server process. A governing policy can involve simple criterion, e.g., whether the requested file exists, or can be more intricate, in which issues such as client authentication, payment for content, geographic location, file size, and connection speed are tested.

If the determination at decision step 46 is affirmative, then control proceeds to step 48. Details of the communication session with the requestor are passed to a download manager. This normally includes the file name or file descriptor, and the socket descriptor.

Next, at step 50 the session between the requestor and the server is terminated. Control then returns to delay step 40.

If the determination at decision step 46 is negative, then control proceeds to step 52. The client request is handled by conventional web server software, rather than by the download manager. Control then continues at step 50, which has been described above.

Download Manager Operation.

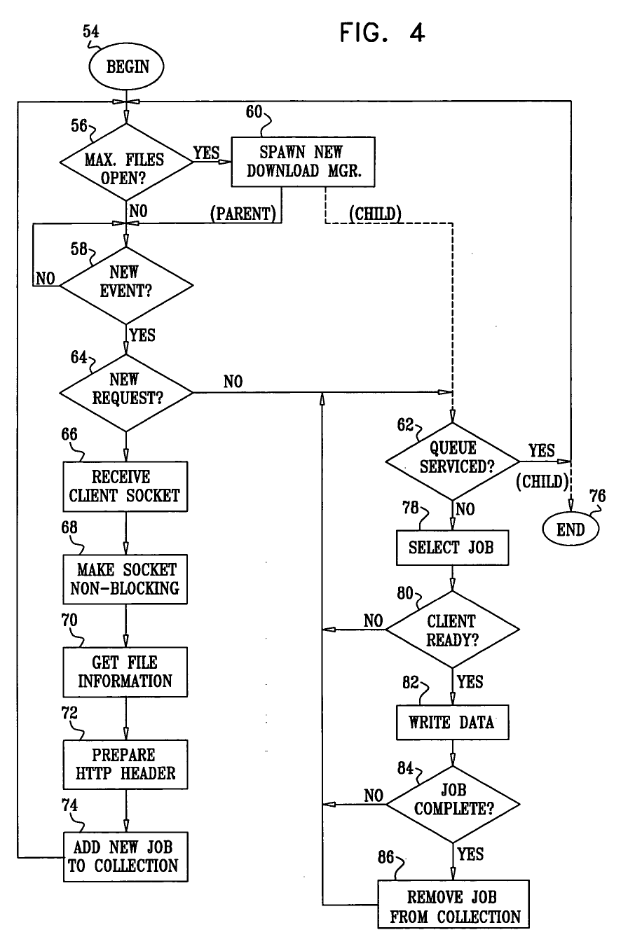

Reference is now made to FIG. 4, which is a flow diagram illustrating the operation of a download manager in accordance with a disclosed embodiment of the invention. The method disclosed with respect to FIG. 4 is conducted concurrently with steps occurring in FIG. 3. Furthermore, FIG. 4 depicts one instance of a sequence of operations in which multiple instances may be conducted concurrently. The first priority of the download manager is to recognize new requests and establish operations with them. Afterward, the download manager processes the queue of pending requests, and attempts to write data to these requests in turn.

At initial step 54 a download manager is initiated in order to begin operations in cooperation with a server program as indicated in step 48 (FIG. 3).

Next, at decision step 56 a determination is made whether a maximum number of files are open. If the determination at decision step 56 is negative, then control proceeds to delay step 58, which is disclosed below.

If the determination at decision step 56 is affirmative, then control proceeds to step 60. The download manager is replicated, typically using a fork( ) system call. The child process continues at decision step 62, while the parent process continues concurrently at delay step 58. In FIG. 4, paths followed exclusively by the child process are displayed as broken lines.

At delay step 58, control waits until an event occurs, which is either one or more new download requests, or notification that existing requests are ready for data to be written out, or both. This can be accomplished by using a blocking select( ) system call on the unnamed socket (FIG. 2) and on all client sockets currently connected to the download manager. The select( ) call is well known in the art, having been added to Unix version 4.2BSD many years ago in order to support a form of non-blocking I/O, and has since been adopted by other operating systems. Prior to the development of the select( ) call, a program needed to actually perform an I/O operation in order to determine if a file descriptor was ready for I/O. The select( ) method enables multiple file descriptors to be queried at the same time.

Next, at decision step 64, a determination is made whether the event that occurred during delay step 58 was the arrival of a new download request. If so, it has been found to be efficient at this point to also determine how many new requests must be handled. This can be accomplished using another, non-blocking select call on the client sockets.

If the determination at decision step 64 is negative, then control proceeds to service the queue of pending download requests beginning at decision step 62, which is disclosed below. Of course, the queues of parent and child download manager processes that may have been established as a result of performing step 60 contain different download requests.

If the determination at decision step 64 is affirmative, then a new request must be integrated into the operations of the download manager. Control proceeds to step 66. A client socket is received.

Next, at step 68, the client socket that was received in step 66 is made non-blocking. This is a key step. It will be recalled that the socket established in the original client contact with the server (FIG. 3) is a conventional socket subject to I/O blocking.

Next, at step 70 file descriptor information relating to the requested download is processed. In some embodiments, the file may be opened.

Next, at step 72 routine HTTP operations are performed preparatory to the download. A HTTP header is prepared for the pending download.

Next, at step 74 the job that has now been prepared is added to a collection of jobs. Control now returns to decision step 56. In embodiments where it is known from decision step 64 that more new download request still need to be handled, and when it is known that the operating system can handle additional open file descriptors, control can optionally return directly to step 66.

The job queue of download requests is serviced in a loop beginning at decision step 62, only after the download manager has determined that no new download requests are pending. A determination is made whether the queue of pending requests has been scanned.

If the determination at decision step 62 is affirmative, the loop has been completed, and control returns to decision step 56 to begin another iteration of the method. However, if decision step 62 is executed by a child process that was spawned in step 60, then the child process terminates at final step 76.

If the determination at decision step 62 is negative, then a job is selected at step 78, according to a predetermined queue discipline. This step can be performed in parallel for all jobs in the collection, and is shown as part of a linear sequence only for purposes of explication. It is meaningful, however, from the perspective of a single processor, which typically performs pseudo-parallel operations.

Next, at decision step 80, a determination is made whether the client associated with the job selected in step 78 is ready to accept data. It is possible, for example, that a block transfer initiated in a previous iteration of the loop has not yet completed.

If the determination at decision step 80 is negative, then control returns to decision step 62.

If the determination at decision step 80 is affirmative, then at step 82 data is written to the client corresponding to the job selected in step 78, using an open socket that connects to the client and includes an appropriate file descriptor. This socket was conditioned in step 66 and step 68.

Next, at decision step 84, a determination is made whether the current job, selected in step 78, is complete. This reflects the common practice of sending data in packets.

If the determination at decision step 84 is negative, then control returns to decision step 62. Otherwise, at step 86, the current job is removed from the queue, and from the collection of pending jobs. Control then returns to decision step 62.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

COMPUTER PROGRAM LISTINGS

Listing 1

/* This sends the file descriptors and extension to the
download manager */
int zend_send_fd(int sock, int from, int to,

char *file_extension)

{

struct iovec vector;
struct msghdr msg;
struct cmsghdr *cmsg;
int *files;
vector.iov_base = file_extension;
vector.iov_len = strlen(file_extension)+1;
msg.msg_name = NULL;
msg.msg_namelen = 0;
msg.msg_iov = &vector;
msg.msg_iovlen = 1;
cmsg = alloca(CMSG_LEN(sizeof(int)*2);
cmsg−>cmsg_len = CMSG_LEN(sizeof(int)*2);
cmsg−>cmsg_level = SOL_SOCKET;
cmsg−>cmsg_type = SCM_RIGHTS;
files = (int *)CMSG_DATA(cmsg);
files[0] = from;
files[1] = to;
msg.msg_control = cmsg;
msg.msg_controllen = cmsg−>cmsg_len;
if (sendmsg(sock, &msg, 0) !=vector.iov_len) {

perror(“sendmsg”);
return −1;

}
return 0;

{

Listing 2

/* This receives the file descriptor and file extension */
int zend_recv_fd(int sock, int *from, int *to,

char *file_extension(

{

struct iovec vector;
struct msghdr msg;
struct cmsghdr *cmsg;
int *files;
vector.iov_base = file_extension;
vector.iov_len = PATH_MAX;
msg.msg_name = NULL;
msg.msg_namelen = 0;
msg.msg_iov = &vector;
msg.msg_iovlen = 1;
cmsg = alloca(CMSG_LEN(sizeof(int)*2);
cmsg−>cmsg_len = CMSG_LEN(sizeof(int)*2);
msg.msg_control = cmsg;
msg.msg_controllen = cmsg−>cmsg_len;
if (!recvmsg(sock, &msg, 0)) {

perror(“recvmsg”);
return −1;

{
files = (int *) CMSG_DATA(cmsg);
*from = files[O];
*to = files[1];
return 0;

}

Listing 3

infinite loop {

wait until exists_new_job_or_abil-

ity_to_write_more_to_running_jobs( );

while (exists_new_job) {

socket = receive_client_socket( );
make_non_blocking(socket);

file_to_be_sent = receive_file_to_be sent( );
file_ptr = memory_map(file_to_be_sent);
file_extension = receive_file_extension( );
header = create_correct_http_header(file_to_be_sent,

file_extension);

jobs_collection.add(new Job(socket, file_ptr,

header, file_extension));

}
foreach job in jobs_collection {

written_data = perform_non_blocking_write_for_job( );
if (error) {

jobs_collection.remove(job);

{
if (written_data < job.data_left_to_write) {

job.adjust_according_to_written_data(written_data);

} else {

jobs_collection.remove(job);

}

}

}

1. A method for downloading data, comprising the steps of:
establishing a connection over a communication network between a remote client and a server, said connection comprising a socket;
receiving a download request from said client via said connection for download of information from said server;
transferring said socket to a download manager process executing on said server; and
transmitting said information to said client from said download manager process using said socket.

2. The method according to claim 1, further comprising the step of converting said socket to a non-blocking socket.

3. The method according to claim 1, wherein said step of transferring said socket comprises the steps of:
constructing a copy of said socket; and
thereafter closing said socket; and
transferring said copy to said download manager process to define a second connection between said download manager process and said client using said copy.

4. The method according to claim 1, wherein said client comprises a plurality of clients, and said steps of establishing a connection, and transferring said socket, and are performed substantially concurrently with respect to each of said plurality of clients.

5. The method according to claim 1, wherein said download request further comprises an indication of a file on said server, further comprising the steps of:
enqueueing said download request in said download manager process with other download requests concurrently being managed therein.

6. The method according to claim 1, wherein said connection comprises a TCP session.

7. The method according to claim 1, wherein said socket of said connection is a blocking socket.

8. The method according to claim 1, wherein said server allows a maximum number of open file descriptors, further comprising the steps of:
spawning a duplicate download manager process when said maximum number of open file descriptors is exceeded;
performing said step of receiving a download request in one of said download manager process and said duplicate download manager process; and
servicing previously pending requests in another of said download manager process and said duplicate download manager process.

9. The method according to claim 1, further comprising the steps of:
accepting new connections for additional clients over said communication network;
establishing respective first threads in said server to operate said connection and said new connections;
establishing a second thread to operate said download manager process; and
communicating between said download manager process and said client and said additional clients via said connection and said new connections respectively using non-blocking I/O.

10. A computer software product, comprising a computer-readable medium in which computer program instructions are stored, which instructions, when read by a computer, cause the computer to perform a method for downloading files from said computer over a data network comprising the steps of:
intercepting a download request for information that is received via a first connection from a remote client, said first connection comprising a socket;
installing a download manager in said computer;
transmitting a set of data comprising said download request and a descriptor of said socket to said download manager to define a second connection between said download manager and said client using said descriptor; and
downloading said information from said computer to said client via said second connection.

11. The computer software product according to claim 10, wherein said client comprises a plurality of clients, and said steps of intercepting a download request, and transmitting a copy of said socket, and downloading said information are performed substantially concurrently with respect to each of said plurality of clients.

12. The computer software product according to claim 10, wherein said computer is further instructed to perform the steps of
after performing the step of transmitting a set of data closing said first connection; and
converting said socket to a non-blocking socket.

13. The computer software product according to claim 10, further comprising the steps of:
enqueueing said download request in said download manager with other download requests concurrently being managed therein.

14. The computer software product according to claim 10, wherein said first connection comprises a TCP session.

15. The computer software product according to claim 10, wherein said socket of said first connection is a blocking socket.

16. The computer software product according to claim 10, wherein said computer allows a maximum number of open file descriptors, further comprising the steps of:
spawning a duplicate download manager when said maximum number of open file descriptors is exceeded;
receiving said set of data in one of said download manager and said duplicate download manager; and
performing said step of download information for previously pending requests in another of said download manager and said duplicate download manager.

17. The computer software product according to claim 10, wherein said computer is further instructed to perform the steps of:
accepting new connections for additional clients;
establishing respective first threads in said server to operate said connection and said new connections;
establishing a second thread to operate said download manager process; and
communicating between said download manager process and said client and said additional clients via said connection and said new connections respectively using non-blocking I/O.

18. A system for downloading information over a data network, comprising:
a server connectable to a plurality of clients across said data network via blocking sockets, said server being adapted to intercept download requests from said clients, and to associate each of said download requests with respective copies of said blocking sockets; and
a download manager executing in said server that receives said download requests and said copies from said server, said download manager being adapted to convert said copies to non-blocking sockets, said server thereupon closing said blocking sockets, wherein said download manager causes said download requests to be serviced from said server across said data network via respective ones of said non-blocking sockets.

19. The system according to claim 18, wherein said download manager is a subassembly of said server.

20. The system according to claim 18, wherein said download manager comprises a queue for holding said download requests, wherein said download requests are serviced in turn from said queue.

21. The system according to claim 18, wherein said server establishes respective first separate threads to operate sockets connecting said server with said clients and establishes a second thread to operate said download manager, said download manager converting said blocking sockets to non-blocking sockets and communicating with said clients via said non-blocking sockets using non-blocking I/O.
